(19) United States
(12) Patent Application Publication
(10) Pub. No.: US 2008/0010986 A1
(43) Pub. Date: Jan. 17, 2008

(54) Turbocharger with catalytic coating

(75) Inventors: Henning Fuhrmann, Zurich (CH); Martin Thiele, Remigen (CH); Tommaso Auletta, Vasteras (SE)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 11/826,019

(22) Filed: Jul. 11, 2007

(30) Foreign Application Priority Data
Jul. 14, 2006 (EP) 06405306.9

(51) Int. Cl. F02B 33/00; B05D 1/12

(52) U.S. Cl. 60/598; 239/13; 415/182.1; 427/372.2

(57) ABSTRACT

A turbo machine having a rotor and a stator is at least partially provided on a flow-guiding part with a catalytic coating. The catalytic coating (7, 7′) comprises at least one oxide of a transition metal or an oxide of a mixture of transition metals, wherein the transition metals are elements from groups I B, in particular Cu, Ag, Ag, II B, in particular Zn, Cd, Hg, III B, in particular Sc, Y, IV B, in particular Ti, Zr, Hf, V B, in particular V, Nb, Ta, VI B, in particular Cr, Mo, W, VII B, in particular Mn, Tc, Re and/or VIII B, in particular Fe, Ru, Os, Co, Rh, Ir, Ni, Pd, Pt.

### FIELD OF THE INVENTION

The invention relates to a compressor in accordance with the preamble of patent claim 1, to a turbocharger having a compressor of this type in accordance with the preamble of patent claim 9 and to a process for producing a compressor in accordance with the preamble of patent claim 10.

### BACKGROUND OF THE INVENTION

It is nowadays common practice to use exhaust-gas turbochargers to boost the power of internal combustion engines. The exhaust-gas turbine of the turbocharger is acted on by the exhaust gases from the internal combustion engine, and the kinetic energy thereof is used for the induction and compression of air for the internal combustion engine. The compression increases the temperature and pressure of the air. As a result, temperatures of 180° C. or higher can occur at the guide vanes of the diffusor and the diffusor walls.

The induction of dirty air can cause impurities to be deposited on that side of the gas inlet housing which faces the medium that is to be compressed, on the compressor wheel or on the diffusor. If the dirty air also contains oil particles, the oil particles in particular become stuck on account of the low surface tension of oil. The highly volatile constituents of the oil are volatilized above 150° C. Coking additionally occurs at temperatures from approximately 180 to 260° C. These effects lead to residues on the surfaces of the walls. The residues form a thick layer with a rough surface. As a result, the efficiency of the compressor can decrease by several percent within a short time.

This problem is encountered in particular in internal combustion engines with crankcase venting. In supercharged internal combustion engines, combustion gases pass between piston rings and liner into the crankcase. Moreover, air enters the crankcase via the oil recirculation line of the turbocharger. These gases are known as blow-by gases. To ensure that the pressure in the crankcase does not rise excessively, the blow-by gases are discharged, fed to the induction air upstream of the compressor wheel and are compressed in the compressor together with the induction air. The blow-by gases contain oil particles, which typically have a diameter of from 0.1 to 10 μm (micrometers) and are in a concentration of from 5 to 10 mg/m³.

To avoid the effects described in the introduction, compressors are cleaned at regular intervals. The cleaning is carried out under part-load. The compressor wheel is rotated at a reduced rotational speed and a liquid is fed to the flow upstream of the compressor wheel.

A device of the type described in the introduction is known from document U.S. Pat. No. 4,196,020, which proposes connecting a removable cleaning spray device to the gas inlet housing of a gas turbine for cleaning purposes. The cleaning spray device comprises collection lines with spray nozzles. For cleaning purposes, the device is fitted to the gas inlet housing, the gas turbine is switched on and via spray nozzles a cleaning liquid is sprayed uniformly onto that side of the gas inlet housing which faces the medium that is to be compressed and onto the compressor wheel. Therefore, this cleaning spray device is mainly used to clean the compressor wheel. Deposits which are stuck to the inside of the gas inlet housing or in the diffusor, which is not moving, are scarcely removed by the finely sprayed liquids. The hotter the compressor becomes, or the higher the compression ratio between the induction air and the compressed air, the greater the extent to which the impurities become stuck to the housing inner wall and the diffusor, and therefore the more difficult it is to remove these impurities. Moreover, compressor operation has to be interrupted before and after each cleaning operation, in order for the cleaning spray device to be attached to the compressor and removed again after cleaning has taken place.

It is known from the technology of ovens to line an oven with a catalytic coating in order to prevent sticking of food oils (U.S. Pat. No. 4,515,862). For this purpose, a catalyst comprising alkali metal oxide or a rare earth alkali metal oxide is mixed with a color, applied to the wall that is to be kept clean and sintered. The temperatures of 200 to 300° C. which are used in ovens are sufficient to decompose the food oils by means of the catalytic coating. The way in which the catalyst is distributed in the color is very important to ensure that it can still provide its catalytic effect.

### SUMMARY OF THE INVENTION

Therefore, it is an object of the present invention to provide a compressor having a gas inlet housing and a compressor wheel, in which the flow-guiding parts are substantially kept clean in particular at high temperatures and in which sticking of oil-containing impurities is substantially avoided. Furthermore, it is intended to provide a turbocharger having a compressor of this type and a process for producing a compressor of this type.

According to the invention, this object is achieved by a compressor having the features of patent claim 1, a turbocharger having the features of claim 9 and a process having the features of patent claim 10.

The compressor according to the invention has a compressor wheel and a gas inlet housing, wherein the flow-guiding parts are at least partially provided with a catalytic coating. The term flow-guiding parts is to be understood as meaning the parts which are arranged in the flow channel or which delimit the flow channel, the flow channel being delimited by those parts of the compressor wheel and gas inlet housing which face the medium that is to be compressed. The catalytic coating decomposes the oil-containing impurities at the temperatures which are typically generated by operation of a turbo machine, thereby largely preventing the impurities from becoming stuck, so that the walls remain clean. Unlike prior art compressors, in which the impurities adhere more securely to the gas inlet housing the higher the temperatures become in this region, in turbo machines according to the invention the catalytic effect becomes even stronger at higher temperatures, and as a result sticking of oil-containing impurities is even more efficiently avoided.

Further advantageous variants and embodiments will emerge from the dependent patent claims.

### BRIEF DESCRIPTION OF THE DRAWINGS

The text which follows provides a more detailed explanation of the process according to the invention and the subject matter of the invention on the basis of a preferred exemplary embodiment, which is illustrated in the accompanying drawings, in which:

The FIGURE shows, in section along the machine axis, an excerpt from a turbocharger having a compressor according to the invention.

The reference designations used in the drawing and the meaning of these designations are summarized in the list of references. The embodiments described are examples of the subject matter of the invention and do not have any restricting action.

### WAYS OF CARRYING OUT THE INVENTION

In the text which follows, the invention is explained on the basis of the example of a turbocharger, comprising a compressor 1 with a compressor wheel 3 and a gas inlet housing 2.

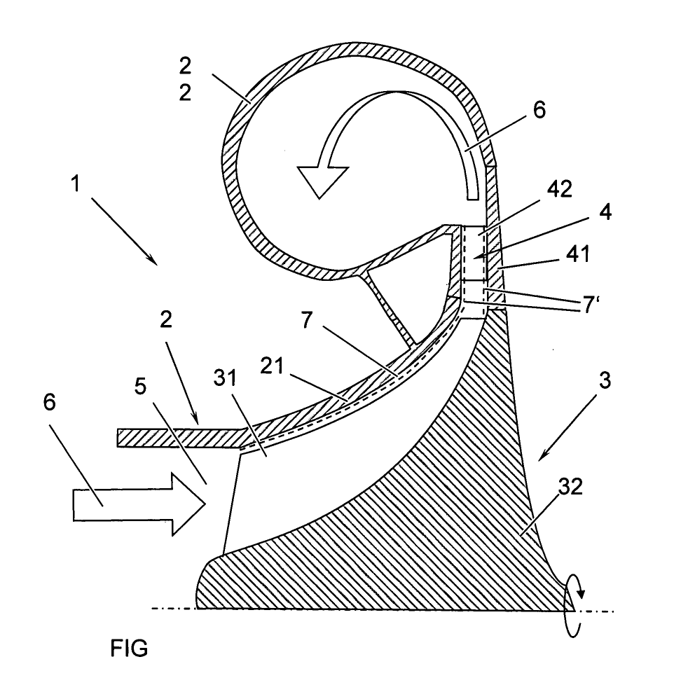

The FIGURE shows, in section along the machine axis of a turbocharger, a compressor-side excerpt from a turbocharger having a compressor 1. The compressor 1 has a gas inlet housing 2, a compressor wheel 3 which is mounted on a shaft (not shown in the FIGURE) and has rotor blades 31 and a hub 32, and a diffusor 4. A turbine wheel is likewise mounted on the shaft (not shown in the FIGURE). The gas inlet housing 2 has a housing inner side 21, which faces the medium that is to be compressed and along which the medium that is to be compressed flows. On the outside, a flow channel 5 is delimited by the housing inner side 21 of the gas inlet housing 2, and on the inside it is delimited by the hub 32 of the compressor wheel 3. The direction of flow of the medium 6 that is to be compressed runs along the flow channel 5 from the opening of the gas inlet housing toward a diffusor 4 (illustrated by arrows in FIG. 1). Downstream of the rotor blades 31, the gas inlet housing 2 merges into a diffusor wall 41 of the diffusor 4. The diffusor 4 comprises guide vanes 42 and diffusor walls 41 which face the medium that is to be compressed and delimit the flow channel 5 on the outside. Downstream, the diffusor merges into a worm casing 22. The compressor 1 is an example of a turbo machine, in which context a turbo machine comprises a rotor and stator, which in the case of the compressor correspond to a compressor wheel 3 and a gas inlet housing 2.

In the compressor 1 according to the invention, flow-guiding parts are at least partially provided with a catalytic coating. Examples of flow-guiding parts are the parts which delimit the flow channel 5 or are arranged in the flow channel, in particular the housing inner side 21, the compressor wheel 3, diffusor walls 41 or diffusor guide vanes 42. In the FIGURE, the compressor 1 has a catalytic coating 7 (illustrated by a dashed line) on the housing inner side 21 of the gas inlet housing 2 and on the diffusor walls 41 and diffusor guide vanes 42. A catalytic coating 7, 7′ can be applied to any other flow-guiding part at which, when the compressor is operating, the temperatures generated are so high that a catalytic effect can take place. The compressor is typically operated at 180 to 300° C. These temperatures are sufficient to produce a catalytic effect in the coating 7, 7′.

The coating 7, 7′ comprises at least one oxide of a transition metal or an oxide of a mixture of transition metals, i.e. an oxide of at least one transition metal. Transition metals are the elements of groups I B (in particular Cu, Ag, Ag), II B (in particular Zn, Cd, Hg), III B (in particular Sc, Y), IV B (in particular Ti, Zr, Hf), V B (in particular V, Nb, Ta), VI B (in particular Cr, Mo, W), VII B (in particular Mn, Tc, Re) and/or VIII B (in particular Fe, Ru, Os, Co, Rh, Ir, Ni, Pd, Pt). In a preferred embodiment, the coating comprises at least one oxide or an oxide of a mixture of elements of in each case these groups of the fourth period (Sc, Ti, V, Cr, Mn, Fe, Co, Ni, Cu, Zn) and/or the fifth period (Y, Zr, Nb, Mo, Tc, Ru, Rh, Pd, Ag, Cd), preferably the fourth period.

In addition, the coating may also comprise at least one metal oxide, preferably Al oxide, or the coating comprises an oxide of a mixture of at least one transition metal and of at least one metal, preferably Al and/or semimetal, preferably Si. Particularly suitable materials for the coating 7, 7′ are oxides of an alloy of TiZrNi, TiCrSi, AlFeCrCo and/or AlFeCuCr.

One suitable example is a coating of an oxide of a mixture of Al in a range from 57 to 85 at %, preferably in a range from 64 to 78 at %, preferably in a range from 64.5 at % to 74.5 at % and in particular 71 at %, Fe in a range from 6.9 to 10.4 at %, preferably in a range from 7.8 to 9.6 at %, preferably in a range from 8.3 to 9.1 at % and in particular 8.7 at %, Cr in a range from 8.5 to 12.7 at %, preferably in a range from 9.5 to 11.7 at %, preferably in a range from 10.1 to 11.1 at % and in particular 10.6 at % and Cu in a range from 7.8 to 11.6 at %, preferably in a range from 8.7 to 10.7 at %, preferably in a range from 9.2 to 10.2 at % and in particular 9.7 at %. The fractions indicated in the mixture should be understood in such a way that the fractions of the metals/transition metals together amount to 100%, in which context the mixture may also comprise further metals/transition metals, i.e. the range details given relate only to the relative ratio of Al, Fe, Cr and Cu to one another; however, it is also possible for further metals/transition metals to be present. A mixture of this type is obtainable, for example, from Saint Gobain under trade name Cristome Al with a composition of 71% Al, 8.7% Fe, 10.6% Cr and 9.7% Cu.

Another suitable coating is an oxide of a mixture of Al in a range from 57 to 85 at %, preferably in a range from 64 to 78 at %, preferably in a range from 64.5 at % to 74.5 at % and in particular 71.3 at %, Fe in a range from 6.5 to 9.7 at %, preferably in a range from 7.3 to 8.9 at %, preferably in a range from 7.7 to 8.5 at % and in particular 8.1 at %, Co in a range from 10.2 to 15.4 at %, preferably in a range from 11.5 to 14.1 at %, preferably in a range from 12.2 to 13.4 at % and in particular 12.8 at %, and Cr in a range from 6.2 to 9.4 at %, preferably in a range from 7.0 to 8.6 at %, preferably in a range from 7.4 to 8.2 at % and in particular 7.8 at %. The fractions given for the mixture are to be understood in such a way that the fractions of the metals/transition metals together add up to 100%, in which context the mixture may also comprise further metals/transition metals, i.e. the range details given relate only to the relative ratio of Al, Fe, Co and Cr to one another; however, it is also possible for further metals/transition metals to be present. A mixture of this type is available for example from Saint Gobain under the trade name Cristome BT1 with a composition of 71.3 at % Al, 8.1 at % Fe, 12.8 at % Co and 7.8 at % Cr.

The catalytic coating 7, 7′ has a long-term heat resistance at the temperatures produced during operation of the turbocharger.

To produce a turbocharger according to the invention, the catalytic coating 7 can be applied to the housing inner side 21 of the gas inlet housing 2 by thermal spraying. Thermal spray-coating processes are described for example in the document “Moderne Beschichtungsverfahren” [Modern coating processes] by F.-W. Bach et al., Wiley-VCH Verlag, 2000.

In the case of a compressor with diffusor 4, it is also conceivable for a catalytic coating 7′ to be applied to the diffusor walls 41. Typical thermal spraying processes include flame spraying, high-velocity flame spraying, arc spraying and plasma spraying. It is advantageous to select a process which produces surfaces of low porosity and/or low roughness. Typically, a transition metal or an alloy of transition metals is applied to the housing inner side 21 of the gas inlet housing 2, in particular by thermal spraying and oxidation of the transition metal or the alloy of the transition metals takes place during the application step, in particular during the thermal spraying.

After the spraying operation, the surface of the catalytic coating 7, 7′ can be treated further until the surface has the desired roughness. On the one hand, a smooth surface is advantageous for operation of the compressor, since such a surface produces little air flow turbulence close to the surface, but on the other hand the catalytic action increases if the surface area is increased, since in this case a larger area of catalytic coating contributes to the catalytic effect.

As a surface treatment for producing the desired roughness, the surface can be smoothed by a suitable process, such as grinding, drag finishing or by means of glass beads. Then, grooves or striations can be deliberately produced again in the surface, for example by sand-blasting, so as to form depressions which increase the surface area of the catalytic coating compared to a smooth surface but which produce scarcely any turbulence, since depressions of this type have only a small influence on the air flow.

The maximum surface roughness should typically not exceed 40 μm (corresponding to an N9 roughness class).

Depending on the particular use and/or depending on the production process, the maximum surface roughness may also be 25 μm (corresponding to an N8 roughness class), 16 μm (corresponding to an N7 roughness class) or even 6.4 μm (corresponding to an N6 roughness class). The roughness average is typically less than 6.3 μm. Depending on the particular application and/or the production process, the roughness average may also be less than 3.2, 1.6 or even 0.8 μm.

### LIST OF REFERENCES

| | |
|---|---|
| 1 | Compressor |
| 2 | Gas inlet housing |
| 21 | Housing inner side |
| 22 | Worm casing |
| 3 | Compressor wheel |
| 31 | Rotor blades |
| 32 | Hub |
| 4 | Diffusor |
| 41 | Diffusor wall |
| 42 | Guide vanes |
| 5 | Flow channel |
| 6 | Direction of flow |
| 7, 7′ | Catalytic coating |

1. A compressor, comprising a compressor wheel and a gas inlet housing and a means which at least partially reduces deposits of dirt on a flow-guiding part, wherein the means is a catalytic coating, and in that the flow-guiding part is at least partially provided with the catalytic coating.

2. The compressor as claimed in claim 1, wherein the catalytic coating comprises at least one oxide of a transition metal or an oxide of a mixture of transition metals, wherein the transition metals are elements from groups I B, in particular Cu, Ag, Ag, II B, in particular Zn, Cd, Hg, III B, in particular Sc, Y, IV B, in particular Ti, Zr, Hf, V B, in particular V, Nb, Ta, VI B, in particular Cr, Mo, W, VII B, in particular Mn, Tc, Re and/or VIII B, in particular Fe, Ru, Os, Co, Rh, Ir, Ni, Pd, Pt.

3. The compressor as claimed in claim 2, wherein the transition metal or the mixture of transition metals is/are elements in each case from groups of the fourth period, in particular Sc, Ti, V, Cr, Mn, Fe, Co, Ni, Cu, Zn and/or the groups of the fifth period, in particular Y, Zr, Nb, Mo, Tc, Ru, Rh, Pd, Ag, Cd, preferably TiZrNi.

4. The compressor as claimed in claim 1, wherein the catalytic coating comprises an oxide of a mixture of at least one transition metal and at least one metal, preferably Al, and/or semimetal, preferably Si, wherein the transition metals are elements from groups I B, in particular Cu, Ag, Ag, II B, in particular Zn, Cd, Hg, III B, in particular Sc, Y, IV B, in particular Ti, Zr, Hf, V B, in particular V, Nb, Ta, VI B, in particular Cr, Mo, W, VII B, in particular Mn, Tc, Re and/or VIII B, in particular Fe, Ru, Os, Co, Rh, Ir, Ni, Pd, Pt.

5. The compressor as claimed in claim 4, wherein the mixture comprises Al in a range from 57 to 85 at %, preferably in a range from 64 to 78 at %, preferably in a range from 64.5 to 74.5 at % and in particular 71 at %, Fe in a range from 6.9 to 10.4 at %, preferably in a range from 7.8 to 9.6 at %, preferably in a range from 8.3 to 9.1 at %, and in particular 8.7 at %, Cr in a range from 8.5 to 12.7 at %, preferably in a range from 9.5 to 11.7 at %, preferably in a range from 10.1 to 11.1 at % and in particular 10.6 at % and Cu in a range from 7.8 to 11.6 at %, preferably in a range from 8.7 to 10.7 at %, preferably in a range from 9.2 to 10.2 at % and in particular 9.7 at %.

6. The compressor as claimed in claim 4, wherein the mixture comprises Al in a range from 57 to 85 at %, preferably in a range from 64 to 78 at %, preferably in a range from 64.5 at % to 74.5 at % and in particular 71.3 at %, Fe in a range from 6.5 to 9.7 at %, preferably in a range from 7.3 to 8.9 at %, preferably in a range from 7.7 to 8.5 at % and in particular 8.1 at %, Co in a range from 10.2 to 15.4 at %, preferably in a range from 11.5 to 14.1 at %, preferably in a range from 12.2 to 13.4 at % and in particular 12.8 at % and Cr in a range from 6.2 to 9.4 at %, preferably in a range from 7.0 to 8.6 at %, preferably in a range from 7.4 to 8.2 at % and in particular 7.8 at %.

7. The compressor as claimed in claim 1, wherein the catalytic coating is a thermally sprayed coating.

8. The compressor as claimed in claim 1, wherein the catalytic coating has a surface with a maximum surface roughness of 40 μm and/or a roughness average of less than 6.3 μm.

9. A turbocharger comprising the compressor as claimed in claim 1.

10. A process for producing the compressor as claimed in claim 1 having a gas inlet housing and a compressor wheel, wherein
a catalytic coating is thermally sprayed onto at least part of a flow-guiding part.

11. The process as claimed in claim 10, wherein
after the catalytic coating has been sprayed on, the surface of the catalytic coating is treated in such a manner as to produce the desired roughness.

12. The process as claimed in claim 11, wherein the treatment of the surface to achieve the desired roughness comprises a step of smoothing the surface followed by a step of producing a predetermined roughness in the smoothed surface.

13. The compressor as claimed in claim 6, wherein the catalytic coating is a thermally sprayed coating.

14. The compressor as claimed in claim 7, wherein the catalytic coating has a surface with a maximum surface roughness of 40 μm and/or a roughness average of less than 6.3 μm.

15. A process for producing the compressor as claimed in claim 8 having a gas inlet housing and a compressor wheel, wherein
a catalytic coating is thermally sprayed onto at least part of a flow-guiding part.

16. The compressor as claimed in claim 5, wherein the catalytic coating is a thermally sprayed coating.
